(19) United States
(12) Patent Application Publication
(10) Pub. No.: US 2004/0227616 A1
(43) Pub. Date: Nov. 18, 2004

(54) Handheld reader and method of testing transponders using same

(75) Inventor: Robert Lafferty, Georgetown (CA)

Correspondence Address: D. PETER HOCHBERG, 1940 E. 6TH STREET, CLEVELAND, OH, 44114, US

(73) Assignee: Mark IV Industries Limited

(21) Appl. No.: 10/439,641

(22) Filed: May 16, 2003

(51) Int. Cl. H04Q 1/00; G05B 19/00

(52) U.S. Cl. 340/5.61; 340/928

(57) ABSTRACT

A handheld reader for testing the validity of a transponder in a mobile communications system, such as an electronic toll collection system. The handheld reader interrogates the transponder under test and receives a response signal. The response signal contains a data string having a sequential plurality of fields, including one field earlier in the sequence than another field. The handheld reader tests the later field for validity and, if invalid, tests the earlier field for validity. Based upon the results of the tests, the handheld reader outputs an indicator signal that provides an assessment of the degree of validity of the data string.

### FIELD OF THE INVENTION

This invention relates to a handheld reader and a method of testing transponders using the handheld reader and, in particular, transponders in a distributed mobile communication system.

### BACKGROUND OF THE INVENTION

Radio frequency transponders and RFID tags are used in a variety of communications systems, especially systems in which a plurality of deployed devices, like vehicles, are outfitted with transponders that communicate with a set of readers connected to a central system. These types of distributed mobile communication systems may employed for electronic toll collection, parking enforcement, valet services, fueling stations, traffic management, and a variety of other purposes.

It is not unusual for a deployed transponder or tag to fail to respond appropriately to a query from a reader. In some cases, the data communicated from the transponder or tag to the reader may be corrupted. There are a number of reasons why data corruption might occur, including operational problems with the transponder, interference from other radio frequency sources, and partial or complete attenuation of signals passing through certain media, such as windshields.

Accordingly, many transponders or tags incorporate some form of error checking into the data string transmitted to the reader. The error checking permits the reader to verify that the data has been received without corruption. If the error checking mechanism indicates a problem, then the entire data string is presumed invalid irrespective of the degree of the data corruption problem.

Readers for known electronic toll systems are be unable to determine whether the data transmission failure is partial or complete or whether it is due to a problem with the transponder, with its placement on the vehicle, or with the communication channel between the transponder and the reader. In some situations it would be beneficial to know if the data is wholly or only partially corrupted, since the data fields of interest in a particular situation may have a high probability of being uncorrupted, and therefore may still be useful.

### SUMMARY OF THE INVENTION

The present invention provides a handheld reader for testing a transponder to assess whether or not the transponder transmits a corrupt data string and the extent of corruption present in the data string.

In one aspect, the present invention provides a method of testing a transponder for an electronic commerce system using a handheld reader. The method includes the steps of transmitting an interrogation signal from the reader to the transponder, and receiving, at the reader, a response signal from the transponder, the response signal including a transponder identification data string having sequential data fields, the data fields including a first field and a second field, wherein the second field is later in the sequence than the first field. The method also includes steps of testing the second field for validity, testing the first field for validity if the second field tests invalid, and outputting an indicator signal based upon the testing steps, where the indicator signal indicates a validity assessment of the transponder identification data string.

In another aspect, the present invention provides a handheld reader for testing a transponder in an electronic commerce system. The handheld reader includes a transmitter for transmitting an interrogation signal to the transponder and a receiver for receiving a response signal from the transponder, the response signal including a transponder identification data string having sequential data fields, the data fields including a first field and a second field, wherein the second field is later in the sequence than the first field. The handheld reader also includes a processor and an output device. The processor tests the second field for validity and, if the second field is invalid, tests the first field for validity. The processor generates an indicator signal based upon the results of the tests, where the indicator signal indicates a validity assessment of the transponder identification data string. The output device receives the indicator signal and generates an output based upon the indicator signal.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Reference will now be made, by way of example, to the accompanying drawings which show an embodiment of the present invention, and in which:

FIG. 1 shows a perspective view of an extent of toll highway employing an electronic toll collection system;

FIG. 2 shows a table of data fields in an example data string;

FIG. 3 shows a block diagram of a handheld reader in accordance with the present invention; and

FIG. 4 shows a flowchart illustrating an embodiment of a method for validating a transponder using a handheld reader, in accordance with the present invention.

Similar numerals are used in different figures to denote similar or like components.

### DESCRIPTION OF SPECIFIC EMBODIMENTS

The detailed description below often refers to transponders. It will be understood that the present invention is not limited to transponders having an active power source, but encompasses all manner of transponders, including passive RFID tags. Nor is the present invention limited to electronic toll collection systems, but rather it applies to any distributed mobile communication system employing transponders or tags. Although the following description depicts a system for an electronic toll highway system, it will be understood that the present invention is not limited to use in connection with an electronic toll highway system.

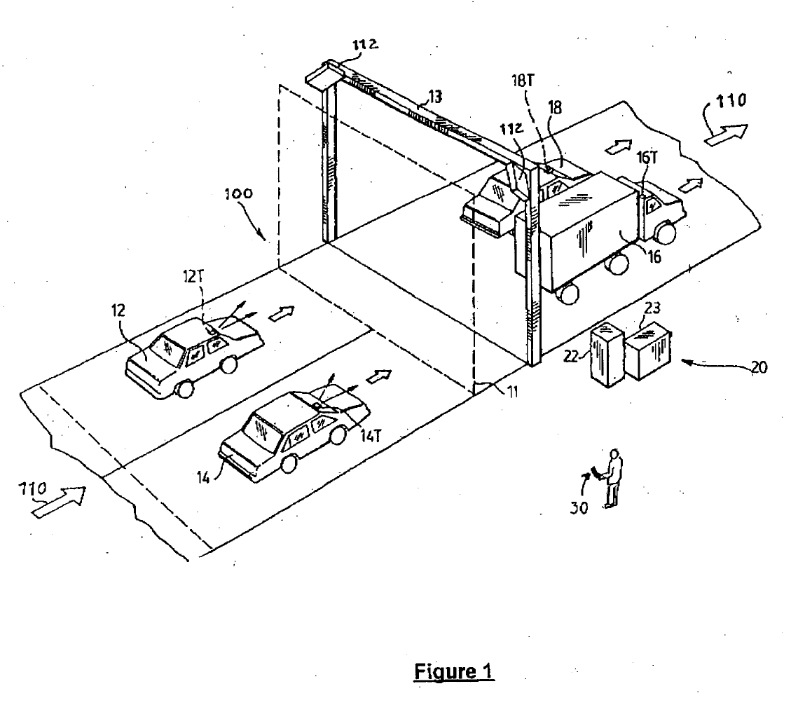

Reference is first made to FIG. 1, which shows an extent of toll highway which represents a communication zone 100 having a downstream direction indicated by arrows 110. At a point which will correspond to an entrance or an exit point from the highway, tolling equipment is provided comprising a photography gantry 11 and, just downstream therefrom, a radio frequency (RF) toll gantry 13 with antennae 112 thereon.

Motor vehicles 12 and 14 are shown approaching the gantries 11, 13 and motor vehicles 16 and 18 are shown having just passed the gantries 11, 13.

A roadside RF system 20 includes a processor 23 which includes the means for coordinating a reader 22, Application Processing (not shown), Angle of Arrival Processor (not shown), their interfaces and data links. The reader 22 communicates with motor vehicle-borne transponders by means of the gantry antennae 112. Such motor vehicle-borne transponders are shown as 12T, 14T, 16T, and 18T.

The protocol for communication between said transponders 12T, 14T, 16T, and 18T and the reader 22 is a two-way RF communications system, forming part of an electronic toll collection system. The RF signals used are normally about 915 Hz and signal at a data bit rate of about 500 kbps. The roadside RF system 20 is part of the electronic toll collection system.

The roadside RF system 20 and the RF toll gantry 13 continually output a signal which will activate a normal transponder circuit within the communications zone 100. Each normal transponder will attempt to activate into one of sevearl activation time slots at random. The reader 22 and the communications protocol will ensure that each communication with the transponders 12T, 14T, 16T, and 18T is in a different time slot. The reader 22 continuously polls for transponders that have not previously communicated or have just entered the zone 100. In another embodiment, the toll gantry 13 is limited in power and range and is disposed so as to ensure only one vehicle is within range of the toll gantry 13 at one time, thereby eliminating the need for a time division multiplexing communication protocol. Other embodiments of an electronic toll highway system will be apparent to those of ordinary skill in the art.

The communication protocol will customarily cause the transponders 12T, 14T, 16T, and 18T to communicate specific data carried in memory. The data includes characteristics, such as the transponder identification code, class type (e.g. standard, commercial, recreational), last entry/exit point and, in some applications, account status or balance and battery condition.

In some cases, the data received by the roadside RF system 20 from one of the transponders 12T, 14T, 16T, and 18T may contain errors. There are any number of reasons why a deployed transponder may transmit data that contains errors. The transponder may be sufficiently far from the roadside RF system 20 such that robust communications are difficult because of the weak signal strength over that transmission distance. RF noise may be present that interferes with the transmitted data. The transponder may be mounted in a location that interferes with its operation, which may sometimes occur when the transponder is mounted inside a windshield. The transponder may also exhibit data loss if the transponder experiences power source problems, such as excessive battery passivation. Other causes of degraded communications between the transponder and the reader 22 may lead to errors in the transmitted data received at the reader 22.

Accordingly, the present invention provides a compact handheld reader 30 for verifying the operational capability of transponders 12T, 14T, 16T, 18T. The handheld reader 30 is intended for use in close proximity to a transponder, so it does not require the power and range associated with the roadside RF system 20, which is required to manage communications over a wide communications zone 100 with a number of transponders that are traveling at highway speeds.

The handheld reader 30 may be employed to verify correct operation of a deployed transponder if the transponder is suspected of failing to respond to a roadside, reader 22. This may be useful in the event of a dispute over the valid operation of a transponder where, for example, an operator at an electronic commerce plaza could confirm whether or not a customer's transponder is operating correctly when it fails to communicate as expected with the central plaza reader. It can also be employed to verity correct operation of a deployed transponder when first installed on a vehicle, especially when the transponder is located within the vehicle. In particular, the handheld reader 30 may be employed to determine whether the patron's windshield is opaque to RF signals, thereby rendering an installed transponder useless. Some vehicles include a metallic coating upon the windshield that causes problems-for transponders. The handheld reader 30 provides a portable and economical test device for verifying correct operation of a transponder.

Although the handheld reader 30 may be employed in connection with an electronic toll collection system, like that shown in FIG. 1, it may be employed in other contexts as well. For example, it may be useful for testing transponders used in commercial vehicle operations monitoring, drive-through payment systems, automated parking lot access systems, and many other systems employing transponders or RFID tags in connection with a mobile electronic commerce system.

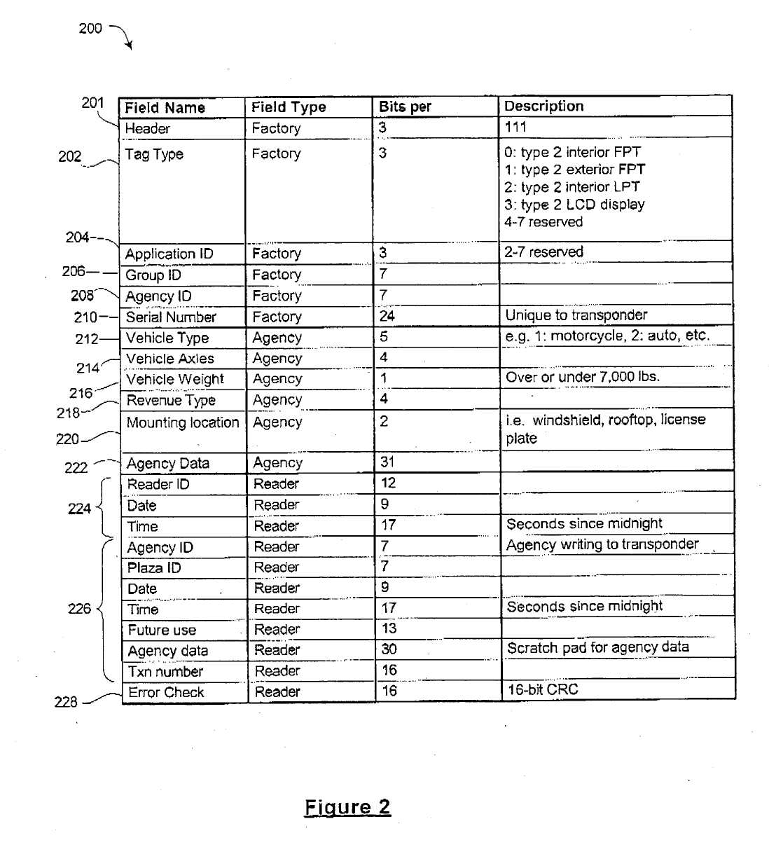

Reference is now made to FIG. 2, which shows a table detailing the structure of an example data string 200 having a plurality of sequential data fields. The string 200 contains three types of fields, as indicated under the chart heading “Field Type”: Factory fields, Agency fields, and Reader fields. The field type identifies what entity is permitted to alter the field contents. The Factory fields are set by the manufacturer of the transponder and tend to relate to the characteristics of the transponder, i.e. the data in the Factory fields is read-only data. The Agency fields are fields that may be set by the agency deploying the transponders, and thus relate to vehicle or customer characteristics. The Reader fields are fields that may be altered by the roadside RF system 20. In one embodiment, these are fields that are used to track the movement of the transponder within an electronic toll collection system. Accordingly, the Reader fields include fields for recording entry and exit points and the time and dates of entry or exit. In other embodiments, the Reader fields may include account information which the roadside RF reader verifies and then debits in an automatic parking system, or other electronic commerce system.

The example data string 200 shown in FIG. 2 contains a number of Factory fields, including a Header field 201, a Tag Type field 202, an Application ID 204, a Group ID 206, an Agency ID 208, and a serial number field 210. Because the Factory fields are set by the manufacturer, the content of the fields is well defined and predictable. For example, within the Tag Type field 202 and the Application ID field 204, there may be certain bit combinations that have not been used for known tags or applications. These bit combinations may be reserved for future use, as the categories of tags and applications develop and expand.

The Agency fields include a Vehicle Type field 212, a Vehicle Axles field 214, a Vehicle Weight field 216, a Revenue Type field 218, a Mounting location field 220, and an Agency Data field 222.

The Reader fields include a set of timing fields 224 altered only by a Traffic Management class of roadside readers 22 and a set of toll collection fields 226 that may be altered by any roadside reader 22. The last field in the example data string 200 is a Reader-class Error Check field 228 containing a 16-bit cyclic redundancy code (CRC). The Error Check field 228 is used by the roadside reader 22 to verify that the data has been received correctly.

Analysis by the inventors has shown that data loss in some specific transponder models and communications tends to follow a consistent pattern. The corruption of the data first begins to appear at the end of the data string. As the corruption increases, it still tends to be concentrated within the later fields in the string, but it begins corrupting fields further up the sequence towards the beginning of the data string. Accordingly, some of the earlier fields in the data string 200 may contain valid data even if the later fields are corrupted. Thus, there are varying degrees of data corruption. The discovery of this pattern of corruption allows for evaluation of the extent of corruption present in a received data string.

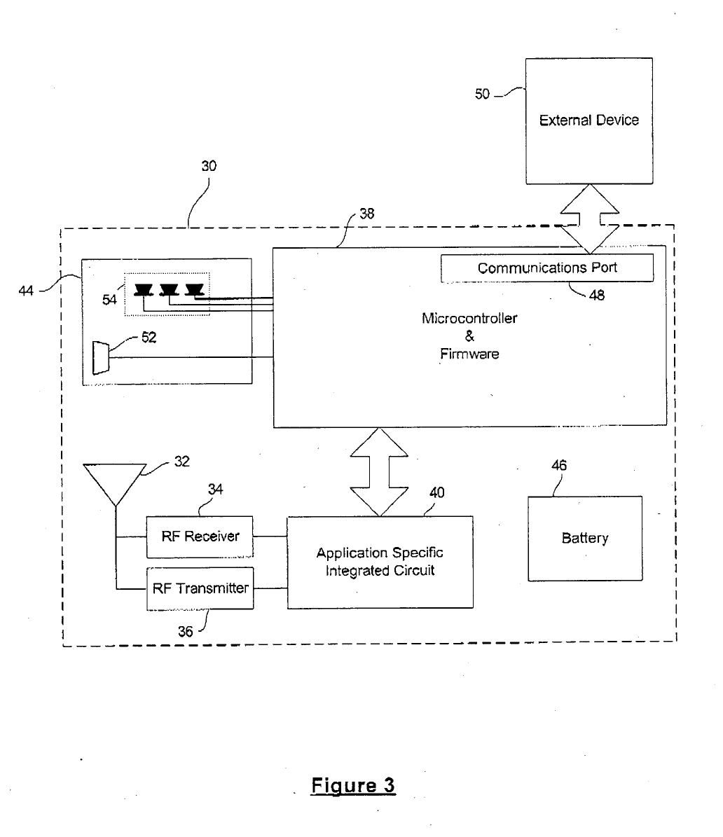

Reference is now made to FIG. 3, which shows a block diagram of an embodiment of the handheld reader 30, in accordance with the present invention. The handheld reader 30 includes an antenna 32 coupled to an RF transmitter 36 and an RF receiver 34. The handheld reader 30 also includes a microcontroller 38 and firmware, an application specific integrated circuit (ASIC) 40, a power source, such as a battery 46, and output indicators 44. In one embodiment, the output indicators 44 include a speaker 52 and a set of light emitting diodes (LEDs) 54.

The microcontroller 38 and the ASIC 40 control the RF receiver 34 and the RF transmitter 36. They cause the transmitter 36 to excite the antenna 32 to transmit an interrogation signal to any transponders within range. Any signals received by the antenna 32 in response to the interrogation signal are detected by the RF receiver 34 and provided to the microcontroller 38 and the ASIC 40. The microcontroller 38 then analyzes the received signals to assess whether or not the signals are corrupted and, if so, to what extent. The ASIC 40 manages low level RF protocol. The microcontroller 38 manages the initiation of communications, the extraction of data from the ASIC 40, the analysis and interpretation of the data, and the other functions described below.

The microcontroller 38 also controls operation of the output indicators 44. The microcontroller 38 may cause auditory signals to be transmitted to the speaker 52 so as to communicate information to the user of the handheld reader 30 about a transponder. Similarly, the microcontroller 38 may illuminate the LEDs 54 in predetermined sequences or patterns in order to communicate information to the user about the status of a transponder under evaluation.

The microcontroller 38 also includes a communications port 48 for managing transmission of data between the microcontroller 38 and an external device 50, such as a personal digital assistant (PDA). Other possible external devices 50 include a barcode reader, a personal computer or other systems that may be used to transmit data, parameters, or instructions to the handheld reader 30 or to receive detailed data regarding any transponders under evaluation by the handheld reader 30. In one embodiment, the microcontroller 38 receives verification data from a barcode reader which reads a barcode label associated with the transponder under evaluation and sends the verification data to the communications port 48.

The microcontroller 38 is configured to execute functions and operations specified in accordance with a program resident in the firmware and in accordance with parameters or instructions received via the communications port 48. The microcontroller 38 and firmware are suitably programmed to execute a transponder validation method in accordance with the present invention.

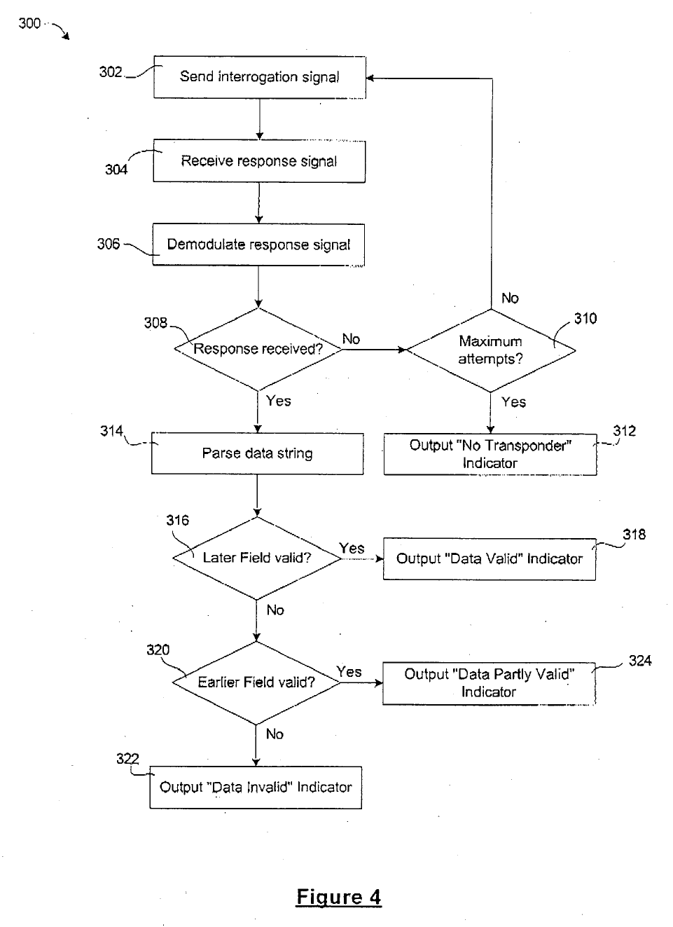

Reference is now made to FIG. 4, which shows a flowchart illustrating an embodiment of a method 300 for validating a transponder using the handheld reader 30 (FIG. 3).

The method 300 begins in step 302 when the handheld reader 30 transmits an interrogation signal. The handheld reader 30 may include an input device, such as a pushbutton, a keypad, or other such input mechanisms, for triggering the handheld reader 30 to transmit an interrogation signal. In another embodiment, the handheld reader 30 may be triggered to being interrogating through a communication from the external device 50.

In one embodiment, the range of the handheld reader 30 is designed to be localized to a few meters so as to restrict the number of transponders that may respond to the interrogation signal. By having a relatively restricted range of operation, the user of the handheld reader 30 can ensure that a specific transponder is the transponder under evaluation. A restricted transmission range also reduces the power requirements of the handheld reader 30.

In step 304, the handheld reader 30 waits for a response signal at its antenna 32 (FIG. 3). Any signals sensed by the antenna 32 and the RF receiver 34 (FIG. 3) are demodulated by the controller 38. (FIG. 3) in step 306. At step 308, the microcontroller 38 evaluates whether or not it has received a transponder response signal. If not, then at step 310 it evaluates whether or not a maximum number of attempts to locate the transponder have been made. If not, then the microcontroller 38 causes the interrogation signal to be transmitted once again in an attempt to cause the transponder under test to respond.

If the maximum number of attempts has been reached, then at step 312 the microcontroller 38 outputs a “no transponder” indicator. The “no transponder” indicator may be an auditory signal, such as a specific set of beeps or tones. It could also be a specific visual indicator, such as a flashing or solid pattern on the LEDs 54 (FIG. 3). The absence of any data indicates that no response was received from the transponder under evaluation, so the handheld reader 30 employs the “no transponder” indicator to communicate to the user that there is either no transponder present or the transponder is completely unresponsive.

If a response signal has been received from a transponder within range, then the microcontroller 38 proceeds to parse the received and demodulated data in step 314. The data includes a data string having a plurality of data fields. The data string will include at least one Earlier Field and one Later Field, where the Earlier Field appears earlier in the data sting sequence than the Later Field. The Earlier Field and the Later Field contain data that may be validated by the microcontroller 38. Such data could, for example, include error-checking data which may be verified by the microcontroller 38. Such data could also include data regarding the transponder that may be verified through data provided from the external device 50, such as a barcode reader that can obtain the data from a barcode label on the transponder. The data could also be validated by the microcontroller 38 in the event that the data for that field is known to fall within a certain range or is known to exclude certain bit combinations or values. Other techniques of validating the content of a data field may be utilized.

With reference to the example data string 200 shown in FIG. 2, in one embodiment, the data string 200 includes the Error Check field 228 containing a 16-bit CRC. In this embodiment, the Error Check field 228 is the last field in the data string and constitutes the Later Field. The Earlier Field may include one or more of the Factory-defined fields, such as the Header field 201, the Tag Type field 202, the Application ID field 204, the Group ID field 206, the Agency Field 208, and/or the serial number field 210. Because these fields are set by the manufacturer, they may contain data that can be verified or validated by the handheld reader 30. For example, the Application ID field 204 may have only certain allocated bit combinations, with other combinations reserved for future use. Accordingly, should the Application ID field 204 in the received data string 200 contain invalid combinations, then the data in the field may be considered invalid. Also by way of example, the serial number field 210 may contain a serial number that should follow a known pattern which can be verified, or it may be cross-referenced with a lookup table of allocated serial numbers and checked against the known Group ID's, Application ID's, or Agency ID's assigned to the transponder of that serial number. Validation may also occur through external verification, such as where the handheld reader 30 includes a barcode reader capable of reading a barcode label associated with the transponder that includes the Factory field data.

Referring still to FIG. 4, in step 316 the microcontroller 38 evaluates the Later Field to assess whether the data is valid Because the Later Field is closer to the end of the data string than the Earlier Field, it is a more sensitive indicator of data corruption, given the pattern in which the corruption tends to manifest itself. In one embodiment, the Later Field is the last field in the data string. In another embodiment, the Earlier Field is within the first half of the data string.

If the Later Field is found to contain valid data, then the entire string may be presumed to be valid, and the microcontroller 38 outputs a “data valid” indicator in step 318. The “data valid” indicator may include an auditory signal or a visible signal through the output indicators 44. It could also include a communication to the PDA 50 or other external device, which may display the results of the evaluation and may perform further evaluation or analysis of the data.

If the Later Field is found to be invalid, then further analysis of the data string is warranted to assess the extent of the corruption. At step 320, the microcontroller 38 evaluates the Earlier Field to assess whether or not its data is valid. If the Earlier Field also proves invalid, then the microcontroller 38 presumes that substantial corruption of the data has occurred and the entire string is deemed invalid. Accordingly, in step 322, the microcontroller 38 causes a “data invalid” indicator to be output.

If the Earlier Field proves to be valid, then the microcontroller 38 concludes that the data string has only been partially corrupted, since only the contents of the Later Field are invalid. Therefore, the microcontroller 38 signals that the data is partially valid by causing a “data partly valid” indicator to be output.

As discussed above, the indicators may include distinctive auditory signals sent to the speaker 52, distinctive light patterns emitted through the LEDs 54, and/or other mechanisms of indicating the results of the evaluation to the user of the handheld reader 30, including transmission of a result signal to the external device 50 through the communication port 48.

It will be understood that the present invention is not limited to a method involving the validation of only two fields within the data string. Multiple fields may be utilized for the purpose of assessing the extent of corruption present in the data. Moreover, it will be appreciated that the present invention is not limited to a method resulting in only three results: valid, invalid, and party valid. The present invention may indicate a plurality of levels of corruption representing the extent of the data string that is found to be invalid.

The present invention may be embodied in other specific forms without departing from the spirit or essential characteristics thereof. Certain adaptations and modifications of the invention will be obvious to those skilled in the art. Therefore, the above discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A method of testing a transponder for an electronic commerce system using a handheld reader, said method comprising the steps of:
(a) transmitting an interrogation signal from said reader to said transponder;
(b) receiving, at said reader, a response signal from said transponder, said response signal including a transponder identification data string having sequential data fields, said data fields including a first field and a second field, said second field being later in said sequence than said first field;
(c) testing said second field for validity;
(d) testing said first field for validity if said second field tests invalid; and
(e) outputting an indicator signal based upon said testing steps, said indicator signal indicating a validity assessment of said transponder identification data string.

2. The method claimed in claim 1, wherein said second field is the last field in said sequence.

3. The method claimed in claim 1, wherein said second field contains an error checking code and wherein said step of testing said second field for validity includes testing the validity of said error checking code.

4. The method claimed in claim 1, wherein said first field includes at least one field in a first half of said transponder identification data string.

5. The method claimed in claim 4, wherein said at least one field contains read-only data, and wherein said step of testing said first field for validity includes comparing said read-only data with expected data.

6. The method claimed in claim 5, wherein said method includes a step of reading data from an external source and wherein said expected data includes said data read from said external source.

7. The method claimed in claim 1, further including a step of outputting said transponder identification data string and said indicator signal to an external device through a communications port.

8. The method claimed in claim 1, wherein said validity assessment includes at least three results, said results including valid, invalid, and partially valid.

9. The method claimed in claim 1, wherein said validity assessment indicates valid data if said second field tests valid.

10. The method claimed in claim 1, wherein said validity assessment indicates invalid data if said first field tests invalid.

11. The method claimed in claim 1, wherein said validity assessment indicates partly valid data if said second field tests valid.

12. A handheld reader for testing a transponder in an electronic commerce system, said handheld reader including:
(a) a transmitter for transmitting an interrogation signal to said transponder;
(b) a receiver for receiving a response signal from said transponder, said response signal including a transponder identification data string having sequential data fields, said data fields including a first field and a second field, said second field being later in said sequence than said first field;
(c) a controller having a module for testing said second field for validity and, if said second field is invalid, testing said first field for validity, said controller generating an indicator signal based upon the results of said tests, said indicator signal indicating a validity assessment of said transponder identification data string; and
(d) an output device for receiving said indicator signal and generating an output based upon said indicator signal.

13. The handheld reader claimed in claim 12, wherein said second field is the last field in said sequence.

14. The handheld reader claimed in claim 12, wherein said second field contains an error checking code and wherein said step of testing said second field for validity includes testing the validity of said error checking code.

15. The handheld reader claimed in claim 12, wherein said first field includes at least one field in a first half of said transponder identification data string.

16. The handheld reader claimed in claim 15, wherein said at least one field contains read-only data, and wherein said module compares said read-only data with expected data.

17. The handheld reader claimed in claim 16, wherein said controller includes communication port for transmitting and receiving data from an external source, and wherein said expected data includes said data from said external source.

18. The handheld reader claimed in claim 12, wherein said controller includes a communications port, and wherein said module includes a output component for transmitting said transponder identification data string and said indicator signal to an external device through said communications port.

19. The handheld reader claimed in claim 12, wherein said validity assessment is selected from the group comprising valid, invalid, and partially valid.

20. The handheld reader claimed in claim 12, wherein said validity assessment indicates partially valid data if said second field tests valid.

21. The handheld reader claimed in claim 12, wherein said output device includes a light emitting diode.

22. The handheld reader claimed in claim 12, wherein said output device includes a speaker.
